(19) United States
(12) Patent Application Publication
(10) Pub. No.: US 2010/0049518 A1
(43) Pub. Date: Feb. 25, 2010

(54) SYSTEM FOR PROVIDING CONSISTENCY OF PRONUNCIATIONS

(75) Inventor: Laurence Ferrieux, Pleumeur Bodou (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/295,217

(22) PCT Filed: Mar. 29, 2007
(86) PCT No.: PCT/FR2007/051040

§ 371 Date: Oct. 5, 2009

(30) Foreign Application Priority Data
Mar. 29, 2006 (FR) 06 51085

(51) Int. Cl. G10L 15/04

(52) U.S. Cl. 704/254; 704/E15.005

(57) ABSTRACT

A system for providing consistency between the pronunciation of a word by a user and a confirmation pronunciation issued by a voice server (1), said voice server comprising both a voice recognition system (20) suitable for recognizing the pronunciation of the word by the user and for associating a text label therewith, and a speech synthesis system (30) suitable for issuing said confirmation pronunciation on the basis of said text label. The text label is a phonetic text label (21) constructed by concatenating the phonemes of the pronunciation as recognized by the voice recognition system (20).

The present invention relates to a system for providing consistency between the pronunciation of a word by a user and a confirmation pronunciation issued by a voice server.

A particularly advantageous application of the invention lies in the field of interactive voice systems making use of voice recognition and of speech synthesis, in particular in the context of applications making use of voice recognition for proper names, such as family names in a directory and contacts in a list, or indeed place names in location recognition systems.

In general, such interactive voice services make use of a voice recognition engine for recognizing what the user says when pronouncing a word, e.g. a proper name, and a speech synthesis engine for sending back to the user a pronunciation that is supposed to confirm the pronunciation uttered by the user when making an inquiry. The confirmation pronunciation is devised by the speech synthesis system on the basis of a text label provided by the voice recognition system. More precisely, the term “label” is used to mean an identifier of what has been recognized by the voice recognition system.

In most existing voice systems, the voice recognition systems used are capable of taking account of several variant pronunciations of one and the same word. With proper names, the number of variant pronunciations that are calculated automatically by a phonetizer on the basis of a single spelling is often large, since the pronunciation of such names is more greatly affected by regional particularities or by the language of origin of the name than is true of common nouns. The differences between two pronunciations of one and the same name can therefore be significant.

Thus, for example, for the proper name “Flécher”, the phonetizer may automatically generate two associated pronunciations, namely: fl_ei_ch_ei and fl_ei_ch_ai_r.

In contrast, the voice synthesis system provides only a single pronunciation for each name starting from a single text label. In the above example, the text label associated with the name “Flécher” is “flécher”, which the speech synthesis system pronounces in the single manner fl_ei_ch_ei.

It should be understood that in a voice system using proper names, there is a major risk of a lack of consistency between the user's pronunciation and the pronunciation played back by the speech synthesis system. This inconsistency is a source of difficulties in continuing with a man/machine dialogue in the context of a directory or a list of contacts, for example.

These difficulties can be illustrated as follows. Imagine that a user is asking a voice directory server for the telephone number of a person having the family name “Flécher” by pronouncing this name fl_ei_ch_ai_r. The voice recognition system, which it should be recalled is capable or of taking account of variant pronunciations for one and the same name, identifies the name as “Flécher” and supplies the speech synthesis system with the single text label “flécher”, which it pronounces in a single manner of the form fl_el_ch_ei. As a result, after making an inquiry about a name pronounced fl_ei_ch_ai_r, the user needs to respond to a confirmation that is the server pronounces fl_ei_ch_ei. Faced with such a situation of apparent incomprehension, the user generally abandons the inquiry.

In order to solve this difficulty, one potential approach for obtaining better consistency between pronunciations would be to transform names that have several variant pronunciations into as many distinct entries having text labels with spellings that give non-ambiguous pronunciations. In the above example, the name “Flécher” would be associated with a first label “fléché” pronounced fl_el_ch_ei by the speech synthesis system, and a second label “fléchaire” that would be pronounced fl_ei_ch_ai_r.

However, such an approach would not enable the system to take advantage directly of variants generated automatically by the phonetizer, since it would be necessary to intervene manually on a case-by-case basis in order to modify the entries and the associated text labels, which cannot be envisaged for applications having large vocabularies such as a national directory having several million entries.

Thus, the technical problem to be solved by the subject matter of the present invention is to propose a system for providing consistency between the pronunciation of a word uttered by a user and a confirmation pronunciation issued by a voice server, said voice server comprising both a voice recognition system suitable for recognizing the pronunciation of the word by the user and for associating a text label therewith, and a speech synthesis system suitable for issuing said confirmation pronunciation on the basis of said text label, which server is capable of solving the above-mentioned difficulties relating to lack of consistency that can occur during dialogues between a user and the server and involving proper names having variant pronunciations, while preserving the advantages of generating these variants automatically by means of the phonetizer.

According to the present invention, the solution to the technical problem posed consists in that said text label is a phonetic text label constructed by concatenating the phonemes of the pronunciation as recognized by the voice recognition system.

Thus, as explained in detail below, consistency is maintained between the recognition and the synthesis mechanisms by using the phonetic transcription of the variant pronunciations generated automatically by the word-phonetizing tool or “phonetizer”. This approach thus avoids manual handling of correspondences that are pseudo-orthographic, i.e. spellings of words that lead to single pronunciations, thereby removing ambiguity.

The method of the invention thus has the effect of associating a recognition result with a label that corresponds to concatenating the phonemes of the variant that has been recognized. In the above example, on recognizing the pronunciation variant fl_ei ch_ai_r the system associates therewith the phonetic text label “fl_ei_ch_ai_r” or “fleichair”, which will be pronounced correctly as fl_ei_ch_ai_r by the speech synthesis system in its confirmation message.

Advantageously, the invention provides for a prosody indicator to be associated with said phonetic text label.

This disposition makes it possible to conserve the prosody as calculated automatically by the system for a complete phrase in which the result word is inserted. For example, proper names tend to be pronounced with the voice being lowered at the end, unlike common nouns.

Hearing the system reformulate the name by using the same pronunciation variant as the user serves to limit any risk of the user refusing the correct solution, merely because of a pronunciation that the user does not recognize.

When the recognized word is used in other actions performed by the system, e.g. searching in a database, a table maintains the correspondence between the spelling of the word and the strings of phonemes corresponding to the variant pronunciations.

The description below with reference to the accompanying drawing, given by way of non-limiting example, shows what the invention consists in and how it can be implemented.

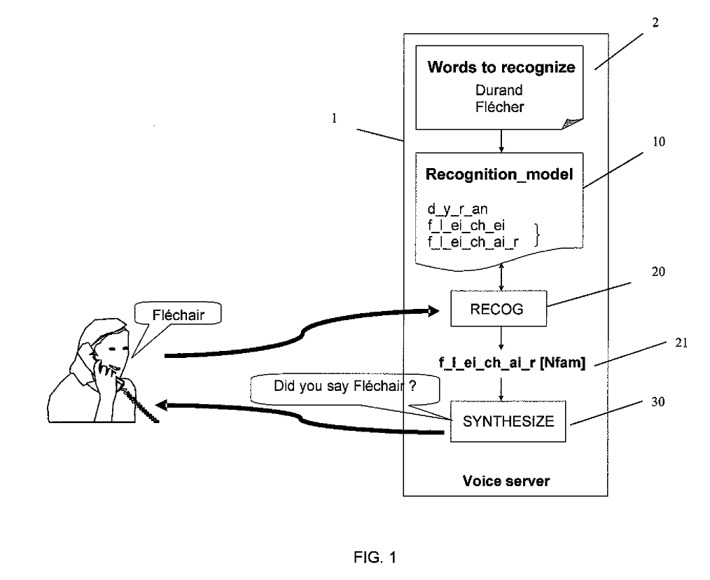

FIG. 1 is a diagram of a voice service system implementing the system of the invention for providing consistency.

By way of example, FIG. 1 shows a voice server 1 associated with a voice telephone directory service.

Starting from a list 2 containing proper names in text mode, such as family names in a directory or contacts in a list, a phonetizer 10 automatically generates the possible pronunciations for the words. Since it is dealing more particularly with proper names, the phonetizer 10 provides a large number of variants that may be associated with regional or foreign origins of the words, or more simply with ambiguity in pronunciation rules that has not been removed by usage.

At the time the recognition model is generated, the system supplies as many entries as there are significant variants. Two entries that differ by a “silent e” will not necessarily be considered as two different variants and may be grouped together under a single text label, which by convention does not include the “silent e”.

In the example shown in FIG. 1, the phonetizer 10 generates a single pronunciation d_y_r_an for the name “Durand”, which name does not have a variant pronunciations, and it generates two pronunciation variants fl_ei_ch_ei and fl_ei_ch_ai_r for “Flécher”.

When the user utters the name to be looked up, here the name “Flécher” pronounced “Fléchair”, i.e. phonetically fl_el_ch_ai_r, the voice recognition system 20 and recognizes this variant pronunciation and transmits a phonetic text label 21 to the speech synthesis system 30, which label corresponds to the list of phonemes that have been recognized, and that can be written “fl_ei_ch_ai_r” or “fleichair”.

The speech synthesis system 30 issues a confirmation message in which the requested name is pronounced correctly as fl_ei_ch_ai_r, matching the initial pronunciation of the user. The confirmation message may be a message that is constructed entirely by synthesis, or it may be a message in a mixed mode that combines recorded segments, such as “Did you say”, and segments that have been synthesized, such as the name as recognized.

In order to ensure that the synthesis system 30 generates correct prosody for the phrase, a prosody indicator is associated with other list of phonemes in order to specify that a family name is involved and that it should be pronounced as specified.

In FIG. 1, it can be seen that the phonetic text label 21 is accompanied by the indicator [Nfam] specifying that the associated list of phonemes, namely in this example fl_ei_ch_ai_r, is to be pronounced as a family name.

Naturally, this prosody indicator can be arbitrary, for example for a family name it could be written [“Dupont”].

1. A system for providing consistency between the pronunciation of a word by a user and a confirmation pronunciation issued by a voice server (1), said voice server comprising both a voice recognition system (20) suitable for recognizing the pronunciation of the word by the user and for associating a text label therewith, and a speech synthesis system (30) suitable for issuing said confirmation pronunciation on the basis of said text label, wherein said text label is a phonetic text label (21) constructed by concatenating the phonemes of the pronunciation as recognized by the voice recognition system (20).

2. A system according to claim 1, wherein a prosody indicator is associated with said phonetic text label (21).
